(19) United States
(12) Patent Application Publication
(10) Pub. No.: US 2012/0026543 A1
(43) Pub. Date: Feb. 2, 2012

(54) IMAGE PROCESSING APPARATUS

(75) Inventors: Takehisa NAKAO, Toyokawa-shi (JP); Keiji KUSUMOTO, Toyokawa-shi (JP)

(73) Assignee: KONICA MINOLTA BUSINESS TECHNOLOGIES, INC., Chiyoda-ku (JP)

(21) Appl. No.: 13/184,932

(22) Filed: Jul. 18, 2011

(30) Foreign Application Priority Data
Jul. 28, 2010 (JP) 2010-169257

(51) Int. Cl. G06K 15/02

(52) U.S. Cl. 358/1.15

(57) ABSTRACT

Provided is an image processing apparatus previously storing information in which an executable output process is associated with a region on an image on which the output process is to be performed, and executing the processes of acquiring a first image, discriminating whether or not the executable output process has been performed on the first image by determining the region on the first image associated with the executable output process, and determining the executable output process discriminated as having been performed on the first image, as a setting for the output process on a second image different from the first image.

This application is based on Japanese Patent Application No. 2010-169257 filed with the Japan Patent Office on Jul. 28, 2010, the entire content of which is hereby incorporated by reference.

### BACKGROUND OF THE INVENTION

1. Field of the Invention

The present invention relates to an image processing apparatus, an image processing system, an image processing method, and a recording medium having an image processing program recorded thereon, and more particularly to an image processing apparatus performing an image forming process based on image data, an image processing system, an image processing method, and a recording medium having an image processing program recorded thereon.

2. Description of the Related Art

When causing an image forming process to be performed using a printer, a copier, an MFP (Multi-Functional Peripheral) thereof or the like as an image processing apparatus, it may be desired that the image forming process be performed under the same processing condition as a document at hand from which an image has already been formed in the image processing apparatus and output.

Herein, in the case of so-called PC print of transmitting an instruction for the image forming process from a personal computer (hereinafter also called PC) as a control apparatus connected via LAN (Local Area Network) or the like, an operation for causing the image forming process to be performed includes an operation of inputting and setting a processing condition in a printer driver using a keyboard of PC or the like.

However, in the above-described conventional operation method, a user should discriminate a processing condition based on a document at hand, and set the discriminated processing condition in the printer driver. There is a problem in that a user unfamiliar to discrimination of a processing condition may find difficulty in discriminating a processing condition based on a document, and may be unable to set a desired processing condition. Another problem lies in that the setting operation is complicated. For solving these problems, the following inventions have been disclosed, for example.

More specifically, Japanese Laid-Open Patent Publication No. 2008-147954 discloses a technique of causing a scanner provided for an image forming apparatus to read a scan condition represented by a bar code or the like added to a document (prescan), and scanning the document based on the scan condition obtained by the process. Japanese Laid-Open Patent Publication Nos. 2002-354212 and 2008-028706 each disclose an operation of inputting a processing condition by reading a dedicated sheet instead of a document.

However, the operation method disclosed in Japanese Laid-Open Patent Publication No. 2008-147954 requires a premise that the processing condition is previously added to the document by means of a bar code or the like. This operation method is therefore disadvantageous in that the same processing condition as that of a usual document without such treatment performed thereon cannot be set based on such document.

Similarly, Japanese Laid-Open Patent Publication Nos. 2002-354212 and 2008-028706 are also disadvantageous due to a premise that a dedicated sheet is prepared previously, and when there is no such sheet, the same processing condition as that of the document cannot be set.

Still another problem lies in that a user unfamiliar to discrimination of a processing condition may find difficulty in discriminating, based on the document at hand, a dedicated sheet corresponding to the processing condition thereof, and may be unable to set a desired processing condition.

### SUMMARY OF THE INVENTION

The present invention was made in view of such problems, and has an object to provide an image processing apparatus that enables easy condition setting for an image forming process, an image processing system, an image processing method, and a recording medium having an image processing program recorded thereon.

To achieve the above-described object, according to an aspect of the present invention, an image processing apparatus includes a controller and a memory, wherein information in which an executable output process is associated with a region on an image on which the executable output process is to be performed is previously stored in a predetermined region of the memory. The controller executes the processes of acquiring a first image, discriminating whether or not the executable output process has been performed on the first image by determining the region on the first image associated with the executable output process, and determining the executable output process discriminated as having been performed on the first image by the process of discriminating, as a setting for an output process on a second image different from the first image.

Preferably, the image processing apparatus is connectable to a control apparatus for making the setting for the output process on the second image for the image processing apparatus. The controller further executes a process of transmitting the setting for the executable output process determined by the process of determining to the control apparatus so as to be usable as the setting for the output process on the second image.

More preferably, the control apparatus makes the setting for the output process on the second image using a printer driver, and the controller transmits, in the process of transmitting, the setting for the executable output process determined by the process of determining to the control apparatus so as to be usable as a setting for the printer driver.

Preferably, the executable output process includes post-processing to be performed on a recording sheet on which the image has been formed, and information in which the post-processing as the executable output process is associated with a region on the image on which the post-processing can be performed is previously stored in the predetermined region of the memory.

More preferably, the post-processing to be performed on the recording sheet includes a stapling process, and information in which the stapling process as the executable output process is associated with a region on the image on which the stapling process can be performed is previously stored in the predetermined region of the memory.

More preferably, the post-processing to be performed on the recording sheet includes a punching process, and information in which the punching process as the executable output process is associated with a region on the image on which the punching process can be performed is previously stored in the predetermined region of the memory.

Preferably, the executable output process includes an image composing process of composing a predetermined image, and information in which the image composing process of composing the predetermined image as the executable output process is associated with a region on the image on which the image composing process can be performed is previously stored in the predetermined region of the memory.

Preferably, the executable output process includes a combining process of combining images of a plurality of pages into a single page, and information in which the combining process as the executable output process is associated with a blank region on the image occurring in the combining process is previously stored in the predetermined region of the memory.

Preferably, the controller acquires data of the first image by scanning a document in the process of acquiring.

Preferably, the controller acquires data of the first image from another apparatus in the process of acquiring.

According to another aspect of the present invention, an image processing system includes an image processing apparatus, and a control apparatus connected to the image processing apparatus. Information in which an executable output process is associated with a region on an image on which the executable output process is to be performed is previously stored in a predetermined region of a memory of the image processing apparatus. A controller of the image processing apparatus executes the processes of acquiring a first image, discriminating whether or not the executable output process has been performed on the first image by determining the region on the first image associated with the executable output process, and transmitting a setting of the executable output process discriminated as having been performed on the first image by the process of discriminating, to the control apparatus. Upon receipt of the setting of the executable output process transmitted from the image processing apparatus, a controller of the control apparatus executes a process of determining the received setting of the executable output process, as a setting for an output process on a second image different from the first image.

Preferably, the control apparatus makes the setting for the output process on the second image using a printer driver, and the controller of the control apparatus determines the setting for the executable output process received from the image processing apparatus, as a setting for an output process in the printer driver.

According to still another aspect of the present invention, an image processing method is a processing method in an image processing apparatus. Information in which an executable output process is associated with a region on an image on which the executable output process is to be performed is previously stored in a predetermined region of a memory of the image processing apparatus. The image processing method includes the steps of acquiring a first image, discriminating whether or not the executable output process has been performed on the first image by determining the region on the first image associated with the executable output process, and determining the executable output process discriminated as having been performed on the first image by the step of discriminating, as a setting for an output process on a second image different from the first image.

Preferably, the image processing apparatus is connectable to a control apparatus for making the setting for the output process on the second image for the image processing apparatus. The image processing method further includes a step of transmitting the setting for the executable output process determined by the step of determining to the control apparatus so as to be usable as the setting for the output process on the second image.

More preferably, the control apparatus makes the setting for the output process on the second image using a printer driver. In the step of transmitting, the setting for the output process determined in the step of determining is transmitted to the control apparatus so as to be usable as the setting for the printer driver.

According to further aspect of the present invention, a recording medium having recorded thereon an image processing program is a recording medium having recorded thereon an image processing program for causing a controller of an image processing apparatus to execute image processing, the recording medium being readable by the controller. Information in which an executable output process is associated with a region on an image on which the executable output process is to be performed is previously stored in a predetermined region of a memory of the image processing apparatus. The image processing program causes the controller to execute the steps of acquiring a first image, discriminating whether or not the executable output process has been performed on the first image by determining the region on the first image associated with the executable output process, and determining the executable output process discriminated as having been performed on the first image by the step of discriminating, as a setting for an output process on a second image different from the first image.

Preferably, the image processing apparatus is connectable to a control apparatus for making the setting for the output process on the second image for the image processing apparatus. The image processing program causes the controller to further execute a step of transmitting the setting for the executable output process determined by the step of determining to the control apparatus so as to be usable as the setting for the output process on the second image.

More preferably, the control apparatus makes the setting for the output process on the second image using a printer driver. In the step of transmitting, the setting for the executable output process determined by the process of determining is transmitted to the control apparatus so as to be usable as the setting for the printer driver.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a specific example of a configuration of an image forming system according to an embodiment.

FIG. 2 is a schematic structural diagram of an image forming apparatus included in the image forming system according to the embodiment.

FIG. 3 shows a specific example of an operation panel of the image forming apparatus.

FIG. 4 is a schematic view showing a hardware configuration of a control unit in the image forming apparatus.

FIG. 5 is a schematic view showing a hardware configuration of a control apparatus.

FIG. 6 is a block diagram showing a control structure in a control unit of an image forming apparatus according to a first embodiment.

FIG. 7 is a flow chart showing the procedure of a discrimination process in the image forming apparatus according to the first embodiment.

FIG. 8 is a flow chart showing a specific example of the procedure of a process of discriminating a processing condition for a stapling process.

FIG. 9 is a flow chart showing a specific example of the procedure of a process of discriminating a processing condition for a stamping process.

FIG. 10 is a flow chart showing the procedure of a discrimination process in an image forming apparatus according to a first variation.

FIG. 11 is a flow chart showing the procedure of a discrimination process in an image forming apparatus according to a second variation.

FIG. 12 is a block diagram showing a control structure of a control apparatus according to a second embodiment.

FIG. 13 is a flow chart showing the procedure of a discrimination process in the control apparatus according to the second embodiment.

FIG. 14 shows specific examples of templates for determining a processing condition in the stapling process.

FIG. 15 shows specific examples of templates for determining a processing condition in the punching process.

FIG. 16 shows specific examples of templates for determining a processing condition in an Nin1 (combining) process.

### DESCRIPTION OF THE PREFERRED EMBODIMENTS

Hereinafter, embodiments of the present invention will be described with reference to the drawings. In the following description, like parts and components are denoted by like reference characters. They are named and function identically as well.

<Configuration of Image Forming System>

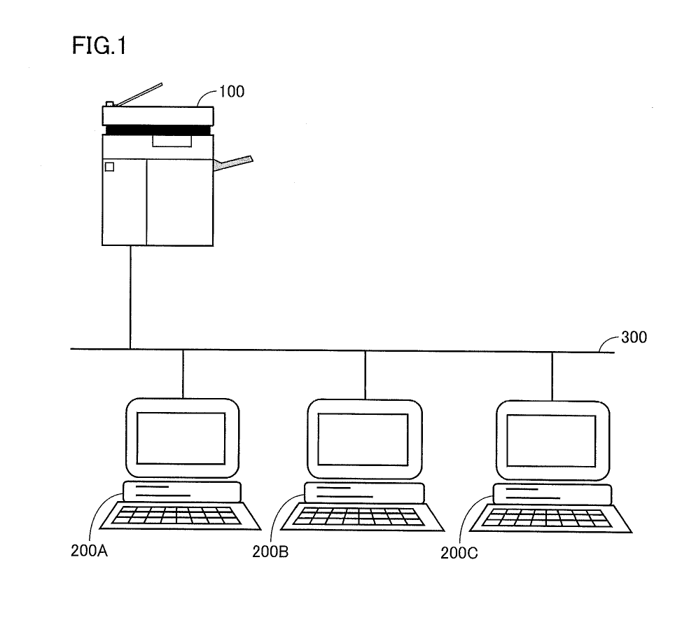

FIG. 1 shows a specific example of a configuration of an image forming system according to the present embodiment. With reference to FIG. 1, the image forming system according to the present embodiment includes an image forming apparatus 100 and a control apparatus 200 for controlling the image forming apparatus, image forming apparatus 100 and control apparatus 200 being connected via a communication line 300, such as LAN (Local Area Network).

FIG. 1 shows an example where a plurality of control apparatuses 200A, 200B, . . . are included. These plurality of control apparatuses 200A, 200B, . . . will be collectively referred to as a control apparatus 200. It is noted that a plurality of control apparatuses 200 are not necessarily required, but the image forming system may include only a single control apparatus.

Control apparatus 200 may be embodied by any apparatus that can communicate with image forming apparatus 100 via communication line 300 and that has input means, such as a keyboard, for inputting control information, which is information for generating a control signal for image forming apparatus 100. Specifically, control apparatus 200 is embodied by a typical personal computer.

<Structure of Image Forming Apparatus>

Image forming apparatus 100 may be embodied by any image forming apparatus that has a scanning function and a printing function. Specifically, image forming apparatus 100 is embodied by a copier, a multi-functional peripheral, or the like. The following will describe an example of an image forming apparatus embodied by a multi-functional peripheral with a plurality of functions mounted thereon, such as a copying function, a printing function, a facsimile function, and a scanner function, and with a print engine capable of full color printing mounted thereon.

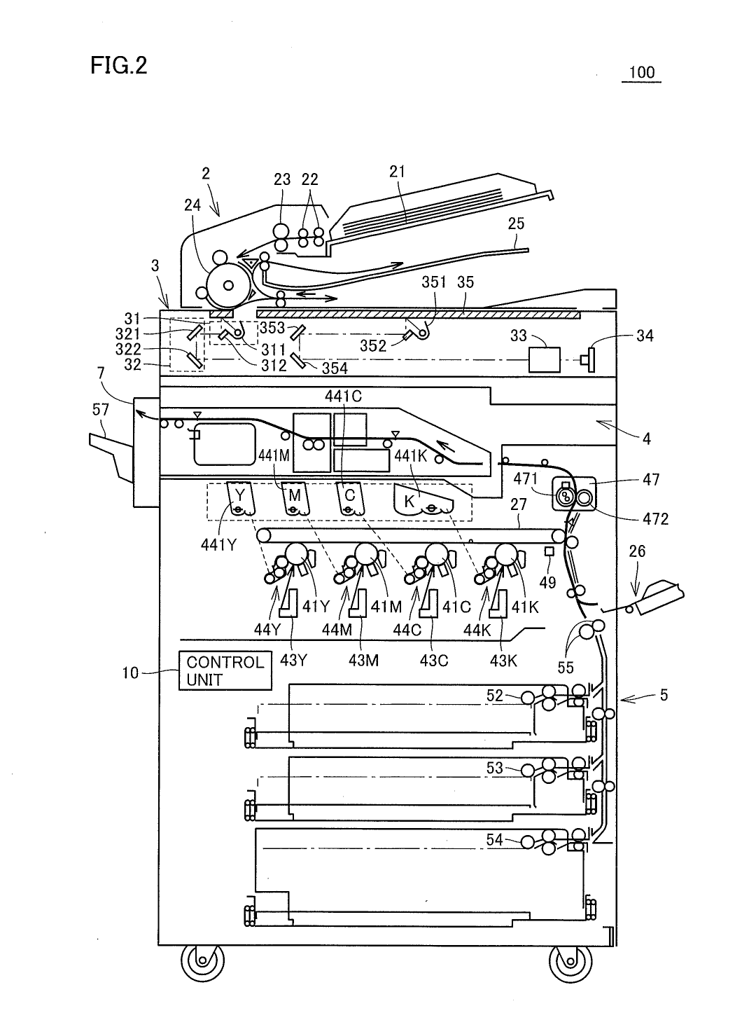

FIG. 2 is a schematic structural diagram of image forming apparatus 100 according to the present embodiment. With reference to FIG. 2, image forming apparatus 100 includes an auto document feeder 2, a scanner 3, a print engine 4, a sheet feeder 5, an operation panel 6, and a post-processing unit 7.

Auto document feeder 2 is provided for performing continuous scanning of documents, and includes a document feed table 21, a feed roller 22, a resist roller 23, a transport drum 24, and a sheet discharge table 25. Documents to be scanned are placed on document feed table 21, and are fed one by one by the operation of feed roller 22. Each fed document is stopped temporarily by resist roller 23 so that the leading edge is aligned, and then transported to transport drum 24. Further, the document rotates integrally with the drum surface of transport drum 24, while scanner 3, which will be described later, scans an image surface. Then, the document is separated from the drum surface of transport drum 24 at a position where the document has made about a half turn on the drum surface, to be discharged to sheet discharge table 25.

Scanner 3 includes a first mirror unit 31, a second mirror unit 32, an imaging lens 33, an image pickup element 34, and a platen glass 35. First mirror unit 31 includes a light source 311 and a mirror 312, and emits light from light source 311 at a position directly under transport drum 24 toward a passing document. Of light emitted from this light source 311, a light beam reflected off the document is reflected off mirror 312 to enter second mirror unit 32. Second mirror unit 32 includes mirrors 321 and 322 disposed in a direction perpendicular to the moving direction of the document, and reflected light from first mirror unit 31 is successively reflected off mirrors 321 and 322 to be led to imaging lens 33. Imaging lens 33 images this reflected light on linear image pickup element 34.

In image forming apparatus 100, it is also possible to acquire image data from a document placed on platen glass 35. In this case, a movable light source 351 and a mirror 352 scan the image surface of the document. With this scanning, light emitted from light source 351 is successively reflected off mirrors 353 and 354 disposed in the direction perpendicular to the moving direction of the document, to be led to imaging lens 33.

Image pickup element 34 converts received reflected light into an electric signal for output to a control unit 10 which will be described later. Image data of the document acquired with scanner 3, that is, an electric signal output from image pickup element 34 is subjected to various types of image processing at control unit 10.

Print engine 4 is capable of full color printout as an example of an electrophotographic image forming process. That is, print engine 4 corresponds to an image forming unit executing an image forming process. Specifically, print engine 4 includes imaging (image forming) units 44Y, 44M, 44C, and 44K that generate toner images of respective colors of yellow (Y), magenta (M), cyan (C), and black (K), respectively. Imaging units 44Y, 44M, 44C, and 44K are disposed in the order presented along a transfer belt 27 extending and driven within print engine 4.

Imaging units 44Y, 44M, 44C, and 44K include image writing units 43Y, 43M, 43C, and 43K and photosensitive drums 41Y, 41M, 41C, and 41K, respectively. Each of image writing units 43Y, 43M, 43C, and 43K includes a laser diode emitting a laser beam in accordance with an image of a corresponding color contained in target image data, and a polygon mirror deflecting this laser beam so that the surface of a corresponding one of photosensitive drums 41Y, 41M, 41C, and 41K is exposed in a main scanning direction.

Exposure by image writing units 43Y, 43M, 43C, and 43K as described above forms electrostatic latent images on the surface of photosensitive drums 41Y, 41M, 41C, and 41K, respectively. These electrostatic latent images are developed as toner images by toner particles supplied from corresponding toner units 441Y, 441M, 441C, and 441K, respectively.

The toner images of the respective colors developed on the surface of photosensitive drums 41Y, 41M, 41C, and 41K, respectively, are successively transmitted to transfer belt 27. This is called primary transfer. Further, the toner images superimposed on transfer belt 27 are further transferred to a recording sheet supplied from sheet feeder 5 with a matched timing. This is called secondary transfer. One of a pair of rollers on which transfer belt 27 is suspended serves as a secondary transfer roller, and the toner images on transfer belt 27 are subjected to the secondary transfer by the pair of rollers to be transferred to the recording sheet supplied to a nip part between the rollers.

The toner images transferred to this recording sheet are fixed at a fixing unit disposed downstream, and the recording sheet is then discharged to a tray 57.

It is noted that the present invention is not limited to the print engine as described above in which toner images of full colors (four colors) are superimposed one upon another, but is also applicable to an image forming apparatus capable of forming toner images of two colors, “black” and “red”, for example.

In parallel with the operation at imaging units 44Y, 44M, 44C, and 44K described above, an area corresponding to a recording sheet to be used for image formation among feed rollers 52, 53, 54, and a manual sheet feeder 26 respectively corresponding to sheet feed cassettes of sheet feeder 5 accommodating recording sheets is activated to supply a recording sheet. This supplied recording sheet is transported by a transport roller 55 and a timing roller, and is fed to the nip part (a secondary transfer unit) of the secondary transfer roller in synchronization with the toner images formed on transfer belt 27.

A fixing device 47 includes a heating roller 471 and a pressure roller 472. Heating roller 471 heats the recording sheet, thereby fusing toner transferred thereon. Further, fused toner is fixed onto the recording sheet through application of a compressive force by heating roller 471 and pressure roller 472. The recording sheet after fixation is then discharged to tray 57 passing through post-processing unit 7. It is noted that a fixing system using a fixing belt or the like, or a non-contact fixing system may be adopted as fixing device 47, instead of the fixing system using the fixing roller as shown in FIG. 2.

Post-processing unit 7 performs post-processing on the recording sheet with toner images formed thereon. The post-processing includes, for example, a punching function of making a hole (punched hole) at a predetermined position, a stapling function of binding a predetermined number of sheets with a staple, and a bookbinding function.

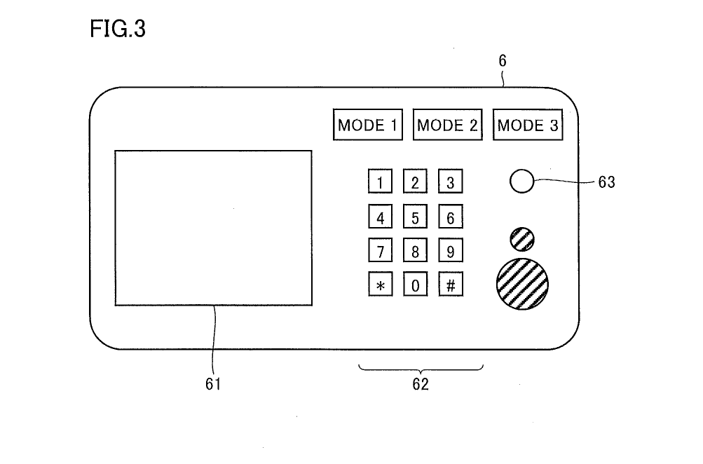

Operation panel 6 is provided on the upper surface of image forming apparatus 100. FIG. 3 shows a specific example of operation panel 6. With reference to FIG. 3, operation panel 6 includes a display 61 and an input unit such as a numeric keypad 62, and further includes a start key 63 for instructing start of reading of a document for discriminating a processing condition of the document, which will be described later.

As used herein, a “processing condition” refers to a condition for a process when processing image data in image forming apparatus 100, details of which will be described later. As used herein, a “process” includes a process for a scanning process, a printing process or a facsimile transmission process, so-called post-processing on a recording sheet with toner images formed thereon, and the like.

<Configuration of Control Unit of Image Forming Apparatus>

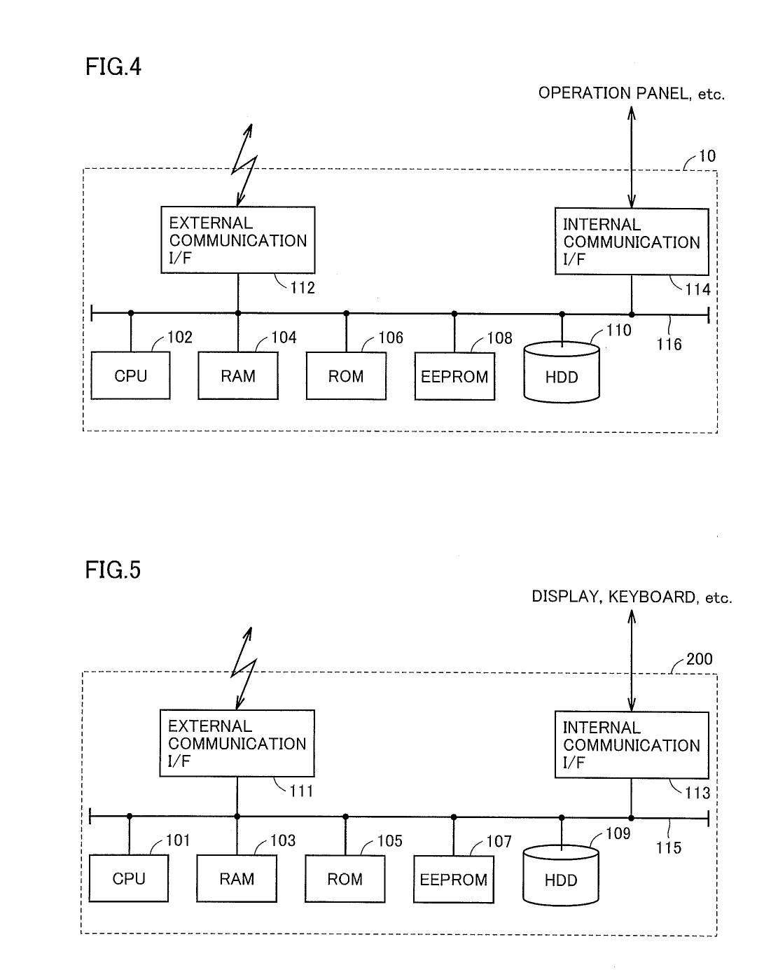

FIG. 4 is a schematic view showing a hardware configuration of control unit 10 in image forming apparatus 100 according to the present embodiment.

With reference to FIG. 4, control unit 10 includes a CPU (Central Processing Unit) 102 as a processing unit, a RAM (Random Access Memory) 104, a ROM (Read Only Memory) 106, an EEPROM (Electrical Erasable and Programmable Read Only Memory) 108, and an HDD (Hard Disk Drive) 110 as storage units, and an external communication I/F (Interface) 112 and an internal communication I/F 114 as communication units. It is noted that these parts are connected together via an internal bus 116.

In control unit 10, CPU 102 develops a program previously stored in ROM 106 or the like for executing various processes to RAM 104 or the like for execution, so that image forming apparatus 100 is controlled.

RAM 104 is a volatile memory, and is used as a work memory of CPU 102. More specifically, in addition to the program per se to be executed, RAM 104 temporarily stores image data to be processed and various types of variable data. EEPROM 108 is typically a nonvolatile semiconductor memory, and stores various set values, such as an IP address and a network domain of image forming apparatus 100. HDD 110 is typically a nonvolatile magnetic memory, and accumulates print jobs received from control apparatus 200, image data acquired with scanner 3, and the like.

External communication I/F 112 typically supports a general-purpose communication protocol such as Ethernet®, and provides data communications with control apparatus 200 or another image forming apparatus via communication line 300.

Internal communication I/F 114, connected to operation panel 6 and the like, receives a signal in accordance with a user's operation on operation panel 6 for transmission to CPU 102, and transmits a signal necessary for displaying a message or the like on operation panel 6 in accordance with a command from CPU 102.

<Configuration of Control Unit of Control Apparatus>

FIG. 5 is a schematic view showing a hardware configuration of control apparatus 200 according to the present embodiment.

With reference to FIG. 5, control apparatus 200 includes a CPU 101 as a processing unit, a RAM 103, a ROM 105, an EEPROM 107, and an HDD 109 as storage units, and an external communication I/F 112 and an internal communication I/F 114 as communication units. It is noted that these parts are connected together via an internal bus 115.

CPU 101 controls control apparatus 200 by developing a program previously stored in ROM 105 or the like for executing various processes to RAM 103 or the like for execution.

RAM 103 is a volatile memory, and is used as a work memory of CPU 101. More specifically, in addition to the program per se to be executed, RAM 103 stores a printer driver which is a program for causing image forming apparatus 100 to execute an image forming process, and the like. EEPROM 107 is typically a nonvolatile semiconductor memory, and stores various set values, such as an IP address and a network domain of control apparatus 200. HDD 109 is typically a nonvolatile magnetic memory, and accumulates print jobs to be transmitted to image forming apparatus 100, image data acquired from image forming apparatus 100, processing conditions received from image forming apparatus 100, and the like.

External communication I/F 111 typically supports a general-purpose communication protocol such as Ethernet, and provides data communications with image forming apparatus 100 or another control apparatus via communication line 300.

Internal communication I/F 113, connected to a keyboard and a display, neither shown, or the like, receives a signal in accordance with a user's operation on the keyboard or the like for transmission to CPU 101, and transmits a signal necessary for displaying a message or the like on the display in accordance with a command from CPU 101.

### First Embodiment

<Operation Procedure>

The following procedure is assumed as the procedure of a user's operation in the first embodiment:

STEP 1 of causing image forming apparatus 100 to read a document for determining a processing condition; and

STEP 2 of causing image forming apparatus 100 to read a document different from the above-described document as an image processing target, or designating a document different from the above-described document from a predetermined region of HDD 110, what is called BOX or the like, for execution of image processing under a processing condition determined from the previous document.

Hereinafter, the document read at STEP 1 above will be called a “condition setting document” as well, and the document read at STEP 2 above will be called a “to-be-processed document” as well.

At STEP 1 above, specifically, a user places a condition setting document on document feed table 21, and presses start key 63. Thus, in image forming apparatus 100, a condition for an image forming process having been performed on original image data of the document is determined from the condition setting document, and is set as a processing condition.

At STEP 2 above, a document different from the condition setting document shall be read or designated as a to-be-processed document, however, it is needless to say that the same document may be read or designated. Moreover, the processing condition determined based on the condition setting document may be automatically applied to an image obtained by reading the condition setting document (without causing the condition setting document to be read as a to-be-processed document again) for execution of image processing.

<Control Structure of Image Forming Apparatus>

Image forming apparatus 100 receives an operation of pressing start key 63 to read a document placed on document feed table 21 as the condition setting document, and determines a condition for the image forming process having been performed on original image data of that document to set the condition as a processing condition.

A processing condition for a process for the scanning process, the printing process, or the facsimile transmission process includes, for example, a color condition indicating a color image or a monochrome image, a document size, a print surface condition indicating double-sided printing or single-sided printing, a layout condition such as a binding margin, a combined number (N) condition for the number of pages in printing image data of a plurality of (N) pages on a single recording sheet, a condition for the position and number of punched holes in the punching process, a condition for the position and number of staples in the stapling process, a condition for bookbinding, and the like. When information such as header, footer or the like is added to image data to form an image, or a predetermined stamp image such as a so-called watermark is added (composed), the processing condition includes a condition for the position and the contents. In the following description, these processes will be collectively referred to as an “image forming process”, and the conditions as described above will be referred to as a “processing condition.”

The control structure of image forming apparatus 100 for executing a process of discriminating and setting a processing condition based on image data obtained by reading a condition setting document will now be described.

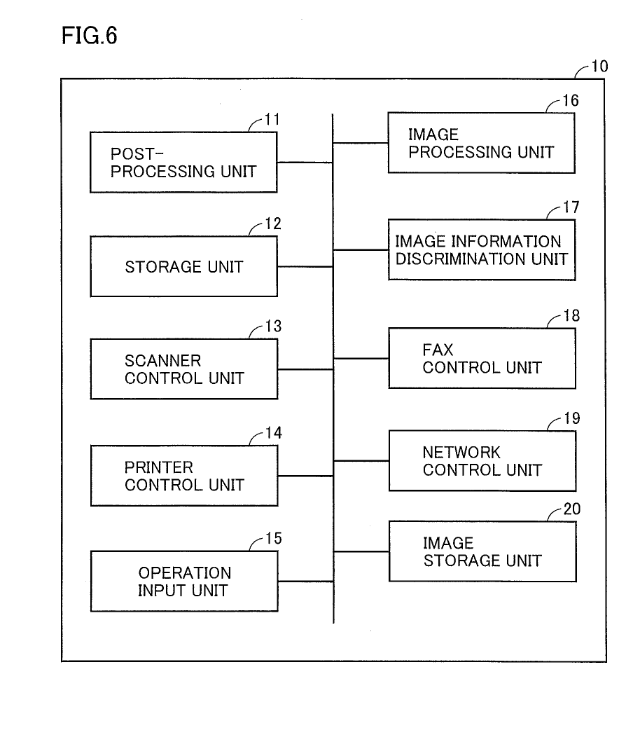

FIG. 6 is a block diagram showing the control structure in control unit 10 of image forming apparatus 100 according to the first embodiment.

With reference to FIG. 6, control unit 10 includes a post-processing control unit 11 for controlling post-processing at post-processing unit 7, a scanner control unit 13 for controlling scanner 3, a printer control unit 14 for controlling print engine 4, an operation input unit 15 for receiving an input of a signal in accordance with a user's operation on operation panel 6, an image processing unit 16 for processing image data, an image information discrimination unit 17 for performing a discrimination process which will be described later to discriminate a processing condition based on image data, a FAX control unit 18 for controlling facsimile communications by controlling the facsimile function, a network control unit 19 for controlling network communications at external communication I/F 112, an image storage unit 20 for storing image data, and a storage unit 12 for storing templates used in the discrimination process which will be described later.

Storage unit 12 and image storage unit 20 are provided as predetermined regions included in RAM 104, EEPROM 108 or HDD 110 (FIG. 4). The remaining portions are typically provided by CPU 102 (FIG. 4) developing a program to RAM 104 (FIG. 4) to execute each command.

Image processing unit 16 processes image data stored in image storage unit 20. Image data processing performed by image processing unit 16 includes the Nin1 process of combining image data of a plurality of (N) pages on a single recording sheet, and the stamping process of composing a prescribed image or character string, such as “Confidential”, as a stamp image at a predetermined position on a recording sheet. The number of pages (N) laid out on a single recording sheet in the Nin1 process, the contents and the position of the stamp image displayed by the stamping process, and the like are included in the processing condition in the image forming process.

The position and/or number of punched holes in the punching process at post-processing unit 7, the position and/or number of staples in the stapling process, and the like are also included in the processing condition in the image forming process.

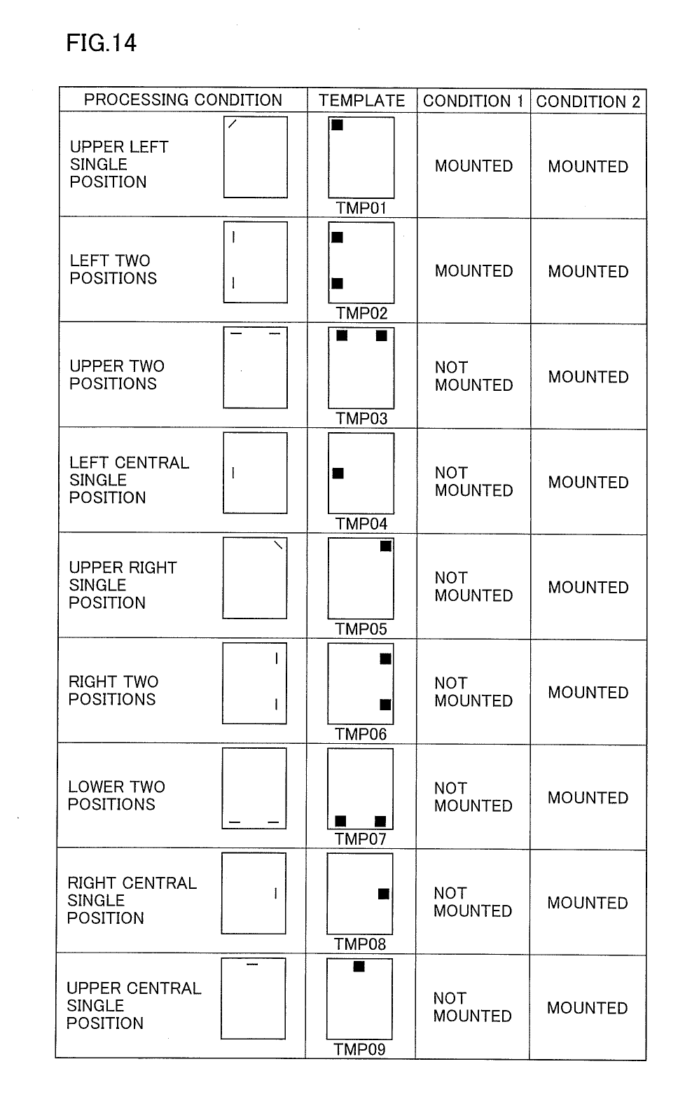

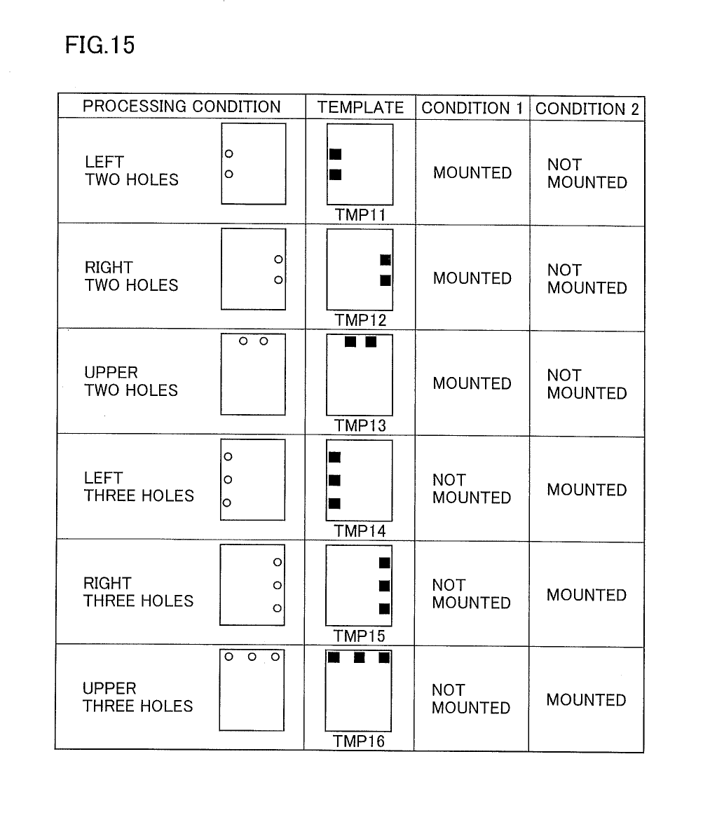

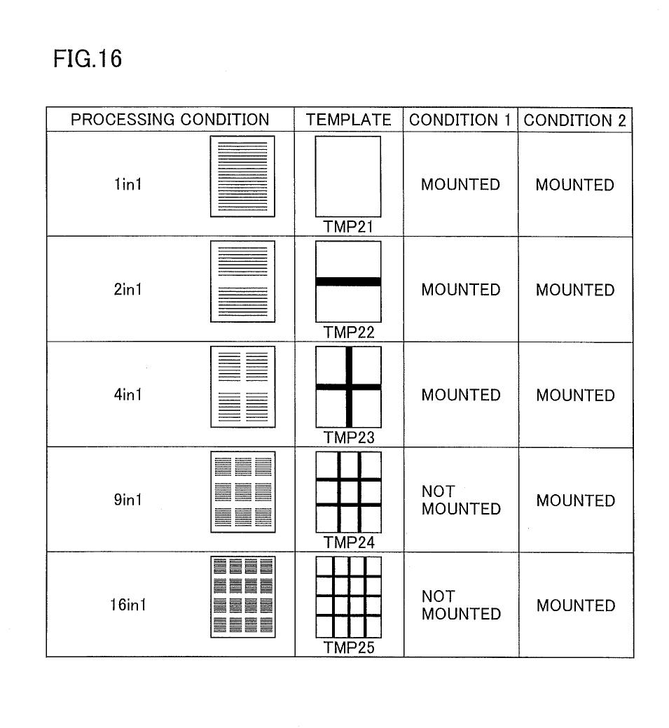

As templates for determining the processing condition from a condition setting document, processing conditions available in image forming apparatus 100 concerned are previously stored in storage unit 12 as image information. FIG. 14 shows specific examples of templates for determining the processing condition in the stapling process. FIG. 15 shows specific examples of templates for determining the processing condition in the punching process. FIG. 16 shows specific examples of templates for determining the processing condition in the Nin1 (combining) process.

With reference to FIG. 14, specific examples of processing conditions in the stapling process include nine types of processing conditions of: “Upper Left Single Position” for stapling sheets at an upper left position; “Left Two Positions” for stapling sheets at upper and lower two positions in proximity to the left side; “Upper Two Positions” for stapling sheets at right and left two positions in proximity to the upper side; “Left Central Single Position” for stapling sheets at a central position in proximity to the left side; “Upper Right Single Position” for stapling sheets at an upper right position; “Right Two Positions” for stapling sheets at upper and lower two positions in proximity to the right side, “Lower Two Positions” for stapling sheets at right and left two positions in proximity to the lower side; “Right Central Single Position” for stapling sheets at a central position in proximity to the right side; and “Upper Central Single Position” for stapling sheets at a central position in proximity to the upper side. Storage unit 12 stores templates, each defining a region (hereinafter referred to as a condition checking region) for checking whether or not the stapling process has been performed under each processing condition (presence or absence of a staple/staples on image data obtained by reading a condition setting document). That is, for the processing condition of “Upper Left Single Position”, a template that defines an upper left region of predetermined range of image data obtained by reading the condition setting document as a condition checking region is stored. For the processing condition of “Left Two Positions”, a template that defines a region of predetermined range of upper and lower two positions in proximity to the left side as a condition checking region is stored. For the processing condition of “Upper Two Positions”, a template that defines a region of predetermined range of right and left two positions in proximity to the upper side as a condition checking region is stored. For the processing condition of “Left Central Single Position”, a template that defines a region of predetermined range of a central position in proximity to the left side as a condition checking region is stored. For the processing condition of “Upper Right Single Position”, a template that defines a region of predetermined range of an upper right position as a condition checking region is stored. For the processing condition of “Right Two Positions”, a template that defines a region of predetermined range of upper and lower two positions in proximity to the right side as a condition checking region is stored. For the processing condition of “Lower Two Positions”, a template that defines a region of predetermined range of right and left two positions in proximity to the lower side as a condition checking region is stored. For the processing condition of “Right Central Single Position”, a template that defines a region of predetermined range of a central position in proximity to the right side as a condition checking region is stored. For the processing condition of “Upper Central Single Position”, a template that defines a region of predetermined range of a central position in proximity to the upper side as a condition checking region is stored.

Similarly, with reference to FIG. 15, specific examples of processing conditions in the punching process include six types of processing conditions of: “Left Two Holes” for making punched holes at upper and lower two positions symmetrical with respect to the center in proximity to the left side of sheets; “Right Two Holes” for making punched holes at upper and lower two positions symmetrical with respect to the center in proximity to the right side; “Upper Two Holes” for making punched holes at right and left two positions symmetrical with respect to the center in proximity to the upper side; “Left Three Holes” for making punched holes at three positions in total of the center in proximity to the left side of sheets and upper and lower two positions symmetrical with respect to the center; “Right Three Holes” for making punched holes at three positions in total of the center in proximity to the right side of sheets and upper and lower two positions symmetrical with respect to the center; and “Upper Three Holes” for making punched holes at three positions in total of the center in proximity to the upper side of sheets and upper and lower two positions symmetrical with respect to the center. Storage unit 12 stores templates, each defining a region for checking whether or not the punching process has been performed under each processing condition (the presence or absence of punched holes on image data obtained by reading a condition setting document), as a condition checking region. Namely, for the processing condition of “Left Two Holes”, a template that defines a region of predetermined range of upper and lower two positions symmetrical with respect to the center in proximity to the left side of image data obtained by reading the condition setting document as a condition checking region is stored. For the processing condition of “Right Two Holes”, a template that defines a region of predetermined range of upper and lower two positions symmetrical with respect to the center in proximity to the right side as a condition checking region is stored. For the processing condition of “Upper Two Holes”, a template that defines a region of predetermined range of right and left two positions symmetrical with respect to the center in proximity to the upper side as a condition checking region is stored. For the processing condition of “Left Three Holes”, a template that defines a region of predetermined range of the three positions in total of the center in proximity to the left side and upper and lower two positions symmetrical with respect to the center as a condition checking region is stored. For the processing condition of “Right Three Holes”, a template that defines a region of predetermined range of the three positions in total of the center in proximity to the right side and upper and lower two positions symmetrical with respect to the center as a condition checking region is stored. For the processing condition of “Upper Three Holes”, a template that defines a region of predetermined range of the three positions in total of the center in proximity to the upper side and upper and lower two positions symmetrical with respect to the center as a condition checking region is stored.

Similarly, with reference to FIG. 16, specific examples of processing conditions in the Nin1 (combining) process include five types of processing conditions of: “1in1” for combining image data of a single page into a single recording sheet; “2in1” for combining image data of two pages; “4in1” for combining image data of four pages; “9in1” for combining image data of nine pages; and “16in1” for combining image data of sixteen pages. Storage unit 12 stores templates, each defining a region for checking whether or not the Nin1 (combining) process has been performed under each processing condition (the presence or absence of a blank/blanks between combined pages on image data obtained by reading the condition setting document), as a condition checking region. Namely, for the processing condition of “1in1”, a template that defines no condition checking region is stored since there is no blank between pages combined into image data obtained by reading the condition setting document. For the processing condition of “2in1”, a template that defines a linear region dividing a sheet longitudinally into two as a condition checking region is stored. For the processing condition of “4in1”, a template that defines a cross region dividing a sheet longitudinally into two and laterally into two as a condition checking region is stored. For the processing condition of “9in1”, a template that defines a lattice region dividing a sheet longitudinally into three and laterally into three as a condition checking region is stored. For the processing condition of “16in1”, a template that defines a lattice region dividing a sheet longitudinally into four and laterally into four as a condition checking region is stored.

As templates for reading a condition for the stamping process as a processing condition, a template that defines the position at which a stamp image is displayed by image processing unit 16 of image forming apparatus 100 concerned as image information, and a template that defines the contents of a stamp image which can be displayed by image processing unit 16 of image forming apparatus 100 concerned as image information are stored.

Upon receipt of an operation signal generated by pressing of start key 63, operation input unit 15 outputs a signal indicating the receipt to scanner control unit 13 and image information discrimination unit 17. Upon receipt of the signal, scanner control unit 13 starts a reading operation of a document (a condition setting document).

Image information discrimination unit 17 acquires image data obtained by scanning the condition setting document with scanner 3, and binarizes the image data for comparison with templates stored in storage unit 12, thereby discriminating a processing condition based on the image data.

As specific examples, image information discrimination unit 17 determines, by pattern matching, whether or not the image data obtained by scanning the condition setting document contains an image corresponding to a staple in each condition checking region in each of the nine types of templates shown in FIG. 14, thereby discriminating a condition for the stapling process corresponding to a template with which the pattern is matched. Similarly, image information discrimination unit 17 determines, by pattern matching, whether or not the image data contains an image corresponding to a punched hole in each condition checking region in each of the six types of templates shown in FIG. 15, thereby discriminating a condition for the punching process corresponding to a template with which the pattern is matched. Similarly, image information discrimination unit 17 determines that the Nin1 process has not been performed when a prescribed number or more of black pixels are present in the prescribed five types of condition checking regions of the image data shown in FIG. 16, and determines that a corresponding Nin1 process has been performed when a prescribed number or more of black pixels are absent at any erase location.

It is noted that cases are assumed where functions mounted on post-processing unit 7 vary with image forming apparatuses. For example, “Condition 1” shown in FIG. 14 represents a case where functions for performing the stapling process under the conditions of “Upper Left Single Position” and “Left Two Positions” among the nine types of processing conditions shown in FIG. 14 are mounted as functions for performing the stapling process, while functions for performing the stapling process under the remaining processing conditions are not mounted. “Condition 2” represents a case where functions for performing the stapling process under all the nine types of processing conditions shown in FIG. 14 are mounted. Similarly, “Condition 1” shown in FIG. 15 represents a case where functions for performing the punching process under the conditions of “Left Two Holes”, “Right Two Holes” and “Upper Two Holes” among the six types of processing conditions shown in FIG. 15 are mounted as functions for performing the punching process, while functions for performing the punching process under the remaining processing conditions are not mounted. “Condition 2” represents a case where functions for performing the punching process under the conditions of “Left Three Holes”, “Right Three Holes” and “Upper Three Holes” are mounted, while functions for performing the punching process under the remaining processing conditions are not mounted. Similarly, “Condition 1” shown in FIG. 16 represents a case where functions for performing the Nin1 (combining) process under the conditions of “1in1”, “2in1” and “4in1” among the six types of processing conditions shown in FIG. 16 are mounted as functions for performing the Nin1 (combining) process, while functions for performing the Nin1 (combining) process under the remaining processing conditions are not mounted. “Condition 2” represents a case where functions for performing the Nin1 (combining) process under all the five types of processing conditions shown in FIG. 16 are mounted.

Storage unit 12 only stores templates corresponding to functions mounted on image forming apparatus 100 concerned. As a result, image information discrimination unit 17 performs pattern matching using the templates stored in storage unit 12, thereby discriminating a processing condition that is discriminated based on image data obtained by scanning a condition setting document and that can be processed by the functions mounted on image forming apparatus 100 concerned.

Alternatively, storage unit 12 may store the templates corresponding to all the processing conditions shown in FIGS. 14 to 16 in association with information indicating whether or not a function corresponding to each processing condition is mounted. In this case, image information discrimination unit 17 makes discrimination only using templates corresponding to processing conditions that can be processed by functions mounted on image forming apparatus 100 concerned. It is noted that the following will describe the example (the former example) where storage unit 12 only stores templates corresponding to functions mounted on image forming apparatus 100.

It is noted that the above-described discrimination methods at image information discrimination unit 17 are merely examples. When the base color of image data is black, for example, the processing condition is discriminated depending on whether or not white pixels are present. In the case of discriminating the document size as a processing condition, a printable region on a document is defined by a template, and the document size can be discriminated by scanning that region of image data upon binarization and finding whether or not a predetermined number or more of pixels of a color opposite to the base color (e.g., black pixels) are present outside that region. A binding margin and the like can be discriminated similarly. In the case of discriminating whether it is a color image or not, a printable region on a document is defined by a template, and whether it is a color image or not can be discriminated by scanning that region of image data and finding whether or not a predetermined number or more of pixels of a color other than white and black are present within that region. In the case of discriminating whether it is both-sided printing or not, image data on both the sides of a target document is acquired previously, and whether it is both-sided printing or not can be discriminated depending on whether or not a predetermined number or more of pixels of a color opposite to the base color (e.g., black pixels) are present in a printing region of the image data on both the sides.

Image information discrimination unit 17 transmits a discrimination result to image processing unit 16 and post-processing control unit 11 as a processing condition. Image processing unit 16 sets the received discrimination result as a processing condition at image processing unit 16. Post-processing control unit 11 sets the received discrimination result as a processing condition at post-processing unit 7.

<Procedure>

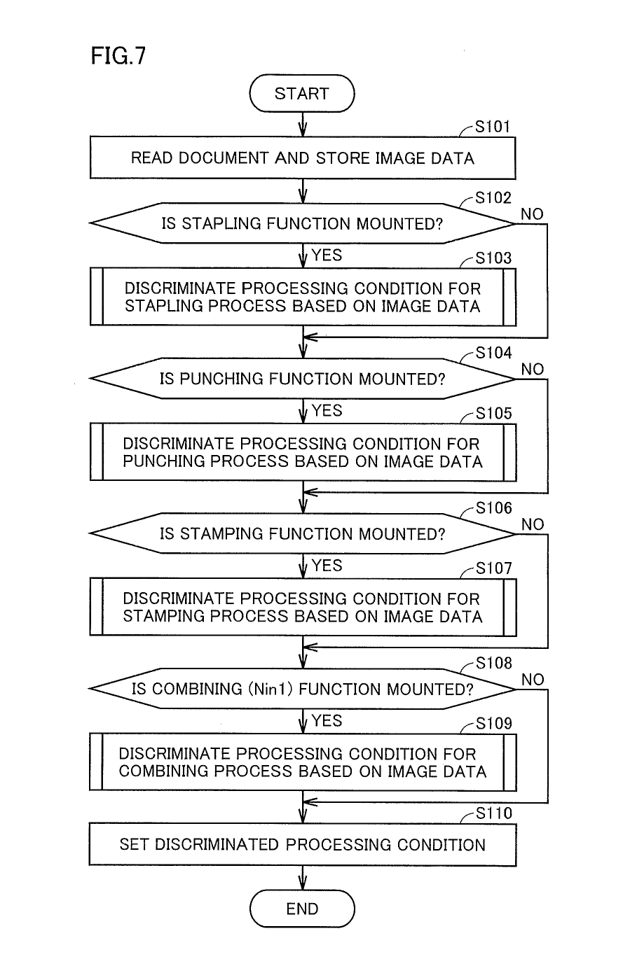

FIG. 7 is a flow chart showing the procedure of a discrimination process in image forming apparatus 100 according to the first embodiment. This process is started by pressing start key 63. The flow chart of FIG. 7 is provided by CPU 102 of control unit 10 (FIG. 4) reading and executing a program stored previously.

With reference to FIG. 7, CPU 102 causes scanner 3 to read a condition setting document, thereby acquiring image data of the document (step S101).

Then, CPU 102 executes a process for discriminating a processing condition for the stapling process based on the acquired image data when the function for performing the stapling process is mounted on image forming apparatus 100 (YES at step S102, step S103), a process for discriminating a processing condition for the punching process when the function for performing the punching process is mounted (YES at step S104, step S105), a process for discriminating a processing condition for the stamping process when the function for performing the stamping process is mounted (YES at step S106, step S107), and a process for discriminating a processing condition for the Nin1 (combining) process when the function for performing the Nin1 process is mounted (YES at step S108, step S109). The order of these processes is not limited to that shown in FIG. 7.

CPU 102 sets a processing condition(s) acquired by these processes as the processing condition for an image forming process (step S110). Then, the process is terminated. It is noted that setting at step S110 may be performed automatically, or a message for confirming whether or not the condition is to be set may be displayed on operation panel 6, so that a setting may be made based on a user's operation in accordance with that message. That is, when a processing condition is discriminated based on the image data obtained from the condition setting document at any of above-described steps S103, 105, 107, and 109, CPU 102 causes operation panel 6 to display a message, for example, for confirming whether or not that processing condition may be set as a processing condition for the image forming process of designated image data, together with buttons for selection between YES and NO, and waits for a user's operation input. When an operation input instructing YES is made, the discriminated condition may be set as a processing condition for the image forming process. When an operation input instructing NO is made, the discriminated condition may be canceled, or may be stored in HDD 110 or the like.

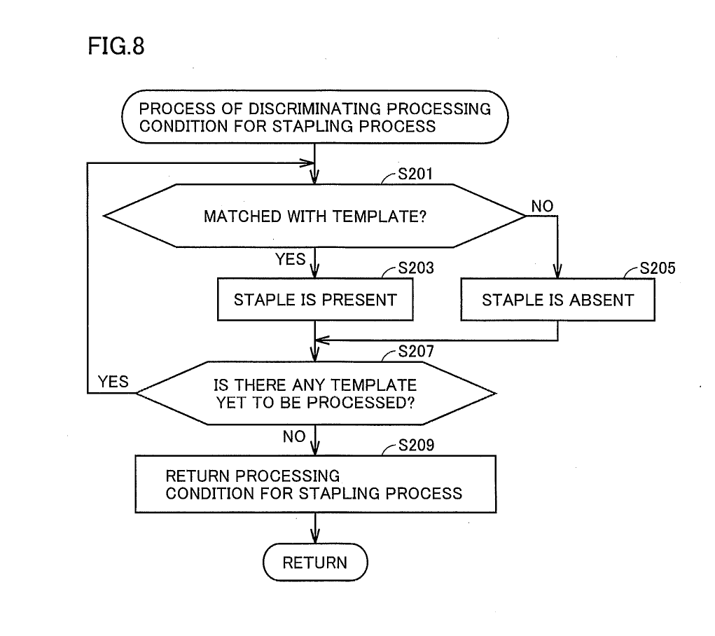

As a process for discriminating a specific processing condition, a process for discriminating the processing condition for the stapling process at step S103 will now be described. FIG. 8 is a flow chart showing a specific example of the procedure of a process for discriminating a processing condition for the stapling process.

With reference to FIG. 8, CPU 102 reads the templates shown in FIG. 14 for discriminating the processing condition for the stapling process stored in storage unit 12 to determine, by pattern matching, whether or not an image corresponding to a staple is present in the condition checking region in the image data obtained at step S101, using each template.

As a result, when a portion in the condition checking region of image data included in a processing target template among the templates shown in FIG. 14 is matched with an image corresponding to a staple (YES at step S201), CPU 102 determines that the stapling process has been performed under the processing condition corresponding to that template (step S203). On the other hand, when any portion in the condition checking region of image data is not matched with an image corresponding to a staple, CPU 102 determines that the stapling process has not been performed on that document under the processing condition corresponding to that template (step S205).

CPU 102 repeats steps S201 to S205 for all the stored templates to specify the presence or absence of a staple for every condition checking region included in each template. Then, when pattern matching is completed for all the stored templates (NO at step S207), CPU 102 returns, as a check result, whether or not the stapling process has been performed, and in the case where the stapling process has been performed, a processing condition that can specify the position and number (step S209) to return the process to the main flow shown in FIG. 7.

Although FIG. 8 shows the process of discriminating a processing condition for the stapling process as an example, the same applies to the process of discriminating a processing condition for another process, such as the punching process or the stamping process.

With such discrimination process performed, CPU 102 can discriminate the processing condition for the image forming process based on a document (a condition setting document) as read. Then, the discriminated processing condition is set as a processing condition for the image forming process in image forming apparatus 100 concerned.

Thereafter or simultaneously with the start of the discrimination process, CPU 102 receives designation of image data of an image processing target, to execute the image forming process of that image data using the discriminated processing condition as a processing condition for the designated image data.

The user can thereby cause the image forming process of the designated image data to be performed in a simple operation under the same processing condition as that of a document at hand, without discriminating the processing condition based on that document by himself/herself or performing a complicated setting operation.

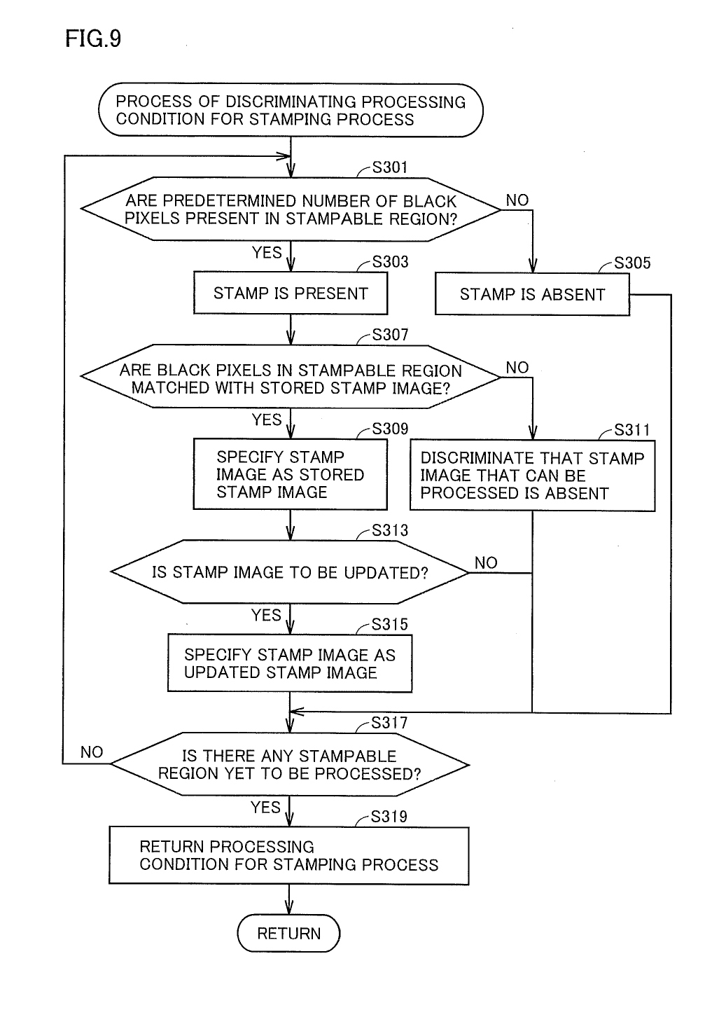

It is noted that, as shown in FIG. 9, the processing condition discriminated based on the document as read may be updated to a new processing condition. FIG. 9 is a flow chart showing a specific example of the procedure of the process for discriminating a processing condition for the stamping process.

With reference to FIG. 9, CPU 102 reads the stored templates for discriminating the processing condition for the stamping process to determine whether or not the image data obtained at step S101 contains a stamp based on that template. Specifically, CPU 102 checks whether or not a predetermined number of black pixels are present for every condition checking region included in the templates.

When a predetermined number of black pixels are present in a condition checking region (YES at step S301), CPU 102 determines that the stamping process has been performed on the condition checking region (step S303). When a predetermined number of black pixels are absent, CPU 102 determines that the stamping process has not been performed on that condition checking region (step S305).

In the process of discriminating the processing condition for the stamping process, when it is discriminated that the stamping process has been performed on the condition checking region, CPU 102 further reads out templates defining stamp images that can be composed in image forming apparatus 100 concerned for comparison with the condition checking region. When a match occurs with the stamp image of any of the stored templates (YES at step S307), CPU 102 specifies the stamp image in that document as a matched stamp image (step S309). When no match occurs with the stamp image of any template (NO at step S307), CPU 102 discriminates that it is not a stamp image that can be composed in image forming apparatus 100 concerned (step S311). It is noted that an exact match is not required herein, but a certain degree of correlation may be determined as a “match.”

Further, when the stamp image of that document is specified, CPU 102 determines whether or not the stamp image is to be updated in accordance with the timing of the image forming process. When the contents of the stamp image represent the date, for example, it is assumed to acquire the date on which the image forming process is executed and updating the contents of the stamp image as read to the acquired date on which the image forming process is executed. When the contents of the stamp image represent user's login information, it is assumed to update the contents to login information of a user who has instructed the image forming process. When the contents of the stamp image represent the storage location of original image data of the condition setting document, it is assumed to update the contents of the stamp image to represent a current storage location of the image data designated as a to-be-processed document. Further, the stamp image may be a designated character string or image based on an operation signal from operation panel 6.

Whether or not to update the stamp image may be determined based on a user's operation in accordance with a message displayed on operation panel 6, for example, for confirming whether or not to update. Alternatively, the contents after update may be acquired dynamically in accordance with a setting made previously, and may be updated automatically. When CPU 102 determines that the stamp image is to be updated (YES at step S313), CPU 102 specifies the stamp image specified from the document as an updated stamp image representing the instructed contents, the prescribed contents or the like (step S315).

CPU 102 repeats steps S301 to S315 for every condition checking region defined by the templates to specify whether or not the stamping process has been performed and the contents for every condition checking region. Then, when specification has been performed for all the condition checking regions defined by the templates (NO at step S317), CPU 102 returns, as a check result, whether or not the stamping process has been performed, and in the case where the stamping process has been performed, also returns the position and the contents as the processing condition for the stamping process (step S319). CPU 102 repeats the above-described steps for each of a plurality of templates stored in storage unit 12, and then returns the process to the main flow shown in FIG. 7.

With such discrimination process performed, CPU 102 can discriminate not only the processing condition in the document as read, but also a processing condition after update based thereon. Therefore, when the user wishes to perform the image forming process of image data under the same processing condition as that of the document having been subjected to the stamping process using a stamp image in accordance with timing of execution of the image forming process, such as the date and time of printing and information on a print executor, he/she can cause the image forming process of designated image data to be easily performed under that processing condition merely by performing a predetermined operation to cause image forming apparatus 100 to read the document, without discriminating the processing condition based on the document, or performing an operation of generating a new stamp image or the like.

It is noted that, when a condition setting document and a to-be-processed document are identical, and when the (original) storage location of image data obtained by reading the condition setting document is discriminated based on that image data, such as when the storage location of image data is composed as a stamp image, as a specific example, CPU 102 may read that image data from the discriminated storage location along with the process of discriminating the processing condition, to automatically set that image data as image data of image processing target.

<First Variation>

The above examples show the cases of setting the processing condition for the image forming process in image forming apparatus 100. However, the image forming system of FIG. 1 may cause control apparatus 200 to control the image forming process in image forming apparatus 100 using a program (driver) for controlling image forming apparatus 100 installed in control apparatus 200.

Specifically, the user causes image forming apparatus 100 to read a condition setting document and to discriminate a processing condition. The processing condition discriminated by image forming apparatus 100 is transmitted to control apparatus 200. Then, the user makes a setting by causing control apparatus 200 to select the processing condition transmitted from image forming apparatus 100 as a processing condition using the above-described driver, and designates image data to be processed, thereby causing control apparatus 200 to output a control signal to image forming apparatus 100. The designated image data will thus be subjected to the image forming process in image forming apparatus 100 under the processing condition discriminated based on the condition setting document.

This case will now be described as a first variation.

In the first variation, network control unit 19 of image forming apparatus 100 outputs a processing condition to control apparatus 200 defined previously.

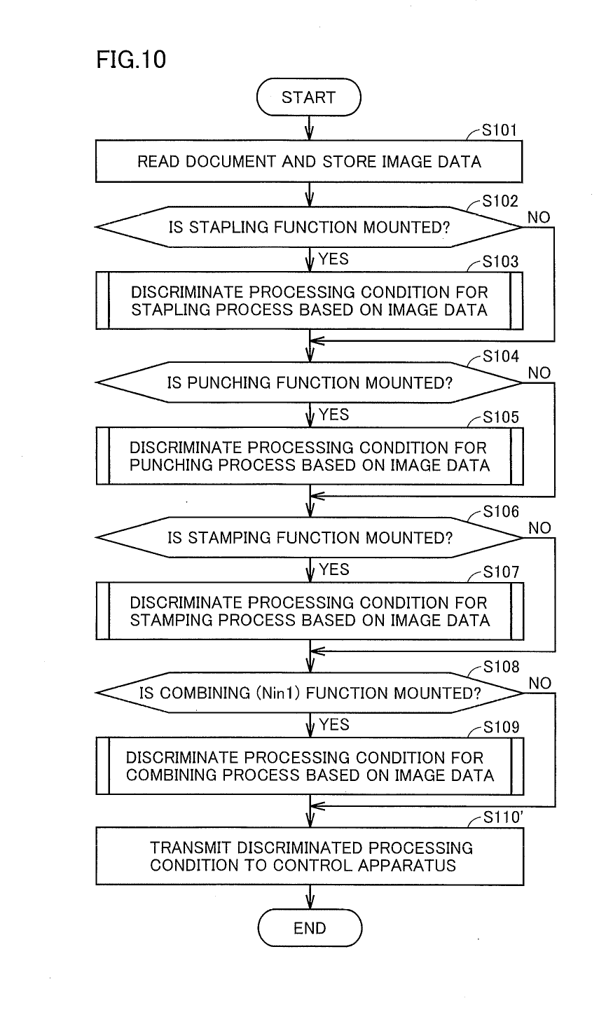

FIG. 10 is a flow chart showing the procedure of a discrimination process in image forming apparatus 100 according to the first variation. In the flow chart of FIG. 10, step S110′ is performed instead of step S110 in the flow chart of FIG. 7. That is, in the first variation, having discriminated a processing condition based on the image data obtained by reading a condition setting document (steps S101 to S109), CPU 102 of image forming apparatus 100 transmits the processing condition to control apparatus 200 previously stored in HDD 110 as a transmission destination (step S110′). Then, the process is terminated. It is noted that each control apparatus 200 as a transmission destination is previously stored in HDD 110 in association with each user, and may be specified in correspondence with login information of a user who has operated image forming apparatus 100 concerned. Alternatively, information that specifies control apparatus 200 as a transmission destination may be input along with an operation input for causing image forming apparatus 100 to read the condition setting document.

Control apparatus 200 sets the processing condition received from image forming apparatus 100 in the driver to generate a control signal for image processing to be sent to image forming apparatus 100.

Thus, in the case of causing image forming apparatus 100 to execute the image forming process using control apparatus 200, merely by performing a predetermined operation to cause image forming apparatus 100 to read a document can similarly cause the processing condition to be also easily set in the driver of control apparatus 200, without discriminating the processing condition based on the document by the user or performing a complicated setting operation in the driver. It is therefore possible to cause image forming apparatus 100 to execute image processing under that condition using control apparatus 200.

It is noted that, in the first variation, control apparatus 200 may have functions for performing image forming processes, such as the Nin1 (combining) process and the process of composing a stamp image. In that case, control apparatus 200 may perform image processing on image data to be processed using a processing condition for an image forming process that can be executed by the functions mounted thereon, among processing conditions received from image forming apparatus 100, and transmit the processed image data to image forming apparatus 100 for output.

Further, the discrimination process in the first variation can also be applied to the case of operating control apparatus 200 to transmit the image data read by image forming apparatus 100 to another apparatus. The method of transmission to another apparatus includes transmission of image data with a facsimile mechanism, transmission of image data with an Internet facsimile through an Internet mechanism, transmission of image data via E-mail, transmission of image data based on a communication protocol such as FPT (File Transfer Protocol), and writing of image data into a recording medium such as a USB (Universal Serial Bus) memory or another storage device, and the like.

In this case, control apparatus 200 reflects the processing condition received from image forming apparatus 100 on a transmission condition setting, and then transmits the image data by the above-described method. Alternatively, image processing of image data may be performed as described above using the processing condition received from image forming apparatus 100 to transmit the processed image data by the above-described method.

Thus, a transmission condition can also be set in a simple operation similarly when transmitting image data, and image data can be transmitted in an intended state, since the state of image data to be transmitted can be previously checked using the document as an example.

<Second Variation>

The above examples show the cases where the target document is read by image forming apparatus 100, and the processing condition is discriminated based on the image data. However, acquisition of image data by image forming apparatus 100 is not limited to reading of the document. As another example, image forming apparatus 100 may also acquire image data of a document which was originally a printed matter by, for example, receipt of image data with a facsimile mechanism, receipt of image data with an Internet facsimile through an Internet mechanism, receipt of image data via E-mail, receipt of image data based on a communication protocol such as FTP, acquisition of image data by reading a recording medium such as a USB memory or another storage device, or the like. Then, image forming apparatus 100 may discriminate a processing condition based on the acquired image data. This case will now be described as a second variation.

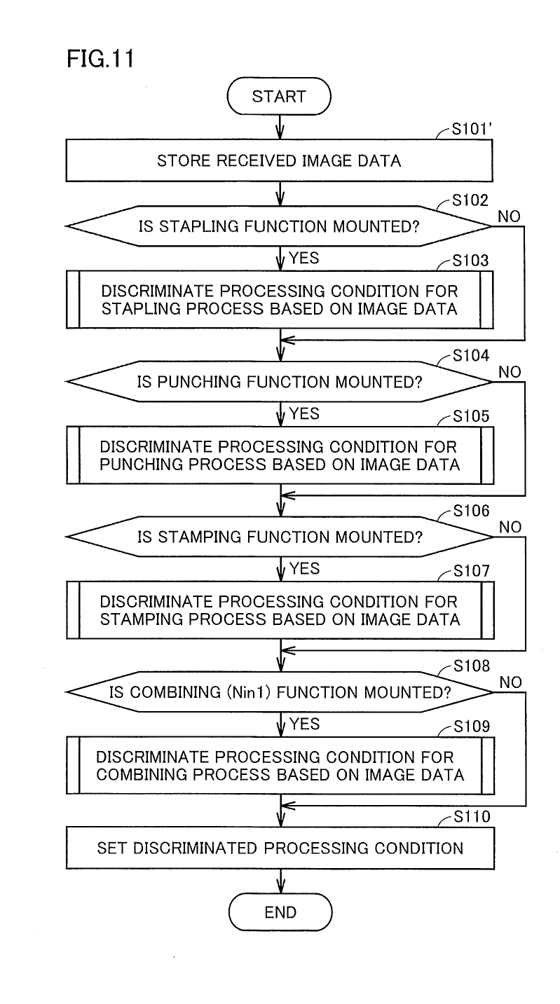

FIG. 11 is a flow chart showing the procedure of a discrimination process in image forming apparatus 100 according to the second variation. In the flow chart of FIG. 11, step S101′ is performed instead of step S101 of the flow chart of FIG. 7. That is, in the second variation, when image data is acquired in image forming apparatus 100 with a facsimile, an Internet facsimile, or the like, CPU 102 stores the image data. Then, CPU 102 discriminates a processing condition for the stapling process based on the received image data when the function for performing the stapling process is mounted (YES at step S102, step S103), a processing condition for the punching process when the function for performing the punching process is mounted (YES at step S104, step S105), a processing condition for the stamping process when the function for performing the stamping process is mounted (YES at step S106, step S107), and a processing condition for the Nin1 (combining) process when the function for performing the Nin1 (combining) process is mounted (YES at step S108, step S109), to set the discriminated processing condition (step S110). Then, the process is terminated. At step S110, the processing condition may be transmitted to control apparatus 200 defined previously, similarly to the first variation.

### Second Embodiment

The first embodiment has described the examples where the processing condition for the image forming process is discriminated in image forming apparatus 100. However, the process of discriminating the processing condition is not only executed in image forming apparatus 100, but also may be performed in control apparatus 200 that is in communication with image forming apparatus 100. This example will now be described in the second embodiment.

<Control Structure of Control Apparatus>

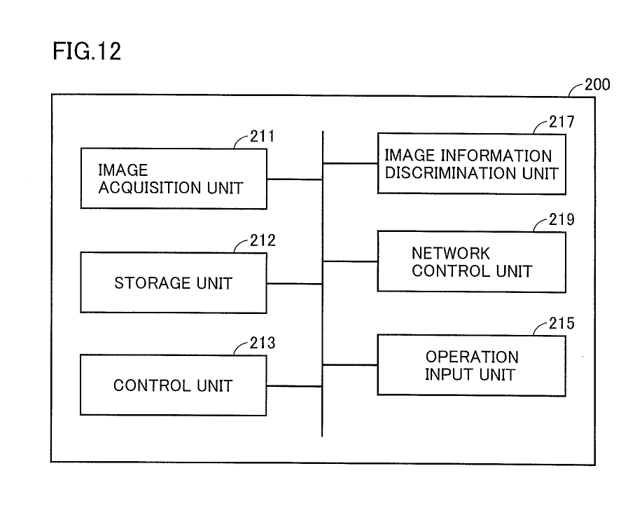

FIG. 12 is a block diagram showing a control structure of control apparatus 200 according to the second embodiment.

With reference to FIG. 12, control apparatus 200 includes an image acquisition unit 211 for acquiring image data, a storage unit 212 for storing templates used in the discrimination process, a control unit 213 for controlling image forming apparatus 100, an operation input unit 215 for receiving an input of a signal in accordance with a user's operation on a keyboard not shown or the like, an image information discrimination unit 217 for performing a discrimination process to discriminate a processing condition based on image data, and a network control unit 219 for controlling network communications via external communication I/F 111.

Storage unit 212 is provided as a predetermined region included in RAM 103, EEPROM 107 or HDD 109 (FIG. 5). The remaining portions are provided typically by CPU 101 (FIG. 5) developing a program to RAM 103 (FIG. 5) to execute each command.

In the second embodiment, storage unit 212 of control apparatus 200 stores templates for determining a processing condition in image forming apparatus 100. It is noted that, when the image forming system includes a plurality of image forming apparatuses, storage unit 212 stores templates for each image forming apparatus. In this case, templates corresponding to an image forming apparatus in which the image forming process is to be performed are used.

Image acquisition unit 211 accesses image forming apparatus 100 or the like in accordance with a signal based on an operation signal from operation input unit 215 to acquire designated image data. A target from which image data is to be acquired may be changed by image forming apparatus 100 or the like.

Image information discrimination unit 217 binarizes the image data acquired by image acquisition unit 211, and then discriminates a processing condition based on that image data using the templates stored in storage unit 212. Image information discrimination unit 217 is similar to image information discrimination unit 17 included in image forming apparatus 100 according to the first embodiment.

<Procedure>

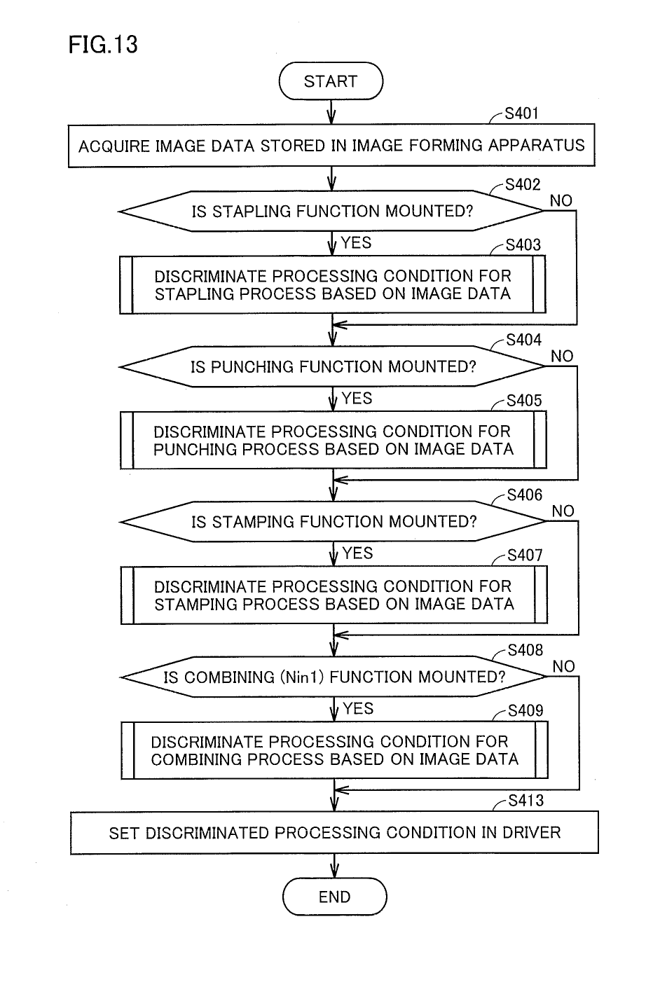

FIG. 13 is a flow chart showing the procedure of the discrimination process in control apparatus 200 according to the second embodiment. This process is started by an input device, such as a keyboard not shown, designating target image data and inputting an instruction to start the process. The flow chart shown in FIG. 13 is provided typically by CPU 101 (FIG. 5) reading and executing a program (driver) for controlling image forming apparatus 100 stored previously.

With reference to FIG. 13, CPU 101 accesses a predetermined apparatus, such as image forming apparatus 100, to acquire designated image data having been obtained by reading a condition setting document (step S401).

Then, CPU 101 executes a process for discriminating a processing condition for the stapling process based on the acquired image data when the function for performing the stapling process is mounted on image forming apparatus 100 in which image data processing is to be executed (YES at step S402, step S403), a process for discriminating a processing condition for the punching process when the function for performing the punching process is mounted (YES at step S404, step S405), a process for discriminating a processing condition for the stamping process when the function for performing the stamping process is mounted (YES at step S406, step S407), and a process for discriminating a processing condition for the Nin1 (combining) process when the function for performing the Nin1 process is mounted (YES at step S408, step S409). These processes are similar to those executed in image forming apparatus 100 according to the first embodiment described with reference to steps S103 to S109 in FIG. 7. The order of processes is not limited to that shown in FIG. 13.

Further, CPU 101 sets the processing condition(s) acquired by these processes in the driver as the processing condition for the image forming process (step S413). Then, the process is terminated.

Thereafter or simultaneously with the start of the above-described discrimination process, control apparatus 200 receives designation of image data of an image processing target to transmit the designated image data or information that specifies the image data to image forming apparatus 100 as image data to be subjected to the image forming process, along with an output process based on the above-described processing condition. Control apparatus 200 can thus cause image forming apparatus 100 to perform the image forming process on the designated image data under the discriminated processing condition.

With such discrimination process performed, CPU 101 of control apparatus 200 can discriminate the processing condition for the image forming process that can be processed in image forming apparatus 100 based on image data stored in image forming apparatus 100 or the like having been obtained by reading the condition setting document. Then, CPU 101 automatically sets the discriminated processing condition in the driver. The user can thus cause image processing to be executed easily under the processing condition for image data stored, even in the case of causing control apparatus 200 to control the image forming process in image forming apparatus 100.

Further, a program for causing image forming apparatus 100 or control apparatus 200 to execute the above-described discrimination process can also be provided. Such a program can be recorded on a computer-readable recording medium, such as a flexible disk attached to a computer, a CD-ROM (Compact Disk-Read Only Memory), a ROM, a RAM, a memory card, or the like, and can be offered as a program product. Alternatively, a program can be offered as recorded on a recording medium such as a hard disk built in a computer. Still alternatively, the program can also be offered by downloading through a network.

It is noted that the program according to the present invention may cause the process to be executed by invoking a necessary module among program modules offered as part of an operating system (OS) of a computer with a predetermined timing in a predetermined sequence. In that case, the program itself does not include the above-described module, but the process is executed in cooperation with the OS. Such a program not including a module may also be covered by the program according to the present invention.

Moreover, the program according to the present invention may be offered as incorporated into part of another program. Also in such a case, the program itself does not include the module included in the above-described other program, and the process is executed in cooperation with the other program. Such a program incorporated into another program may also be covered by the program according to the present invention.

An offered program product is installed in a program storage unit, such as a hard disk, and is executed. It is noted that the program product includes a program itself and a recording medium on which the program is recorded.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image processing apparatus comprising:
a controller; and
a memory, wherein
information in which an executable output process is associated with a region on an image on which said executable output process is to be performed is previously stored in a predetermined region of said memory, and
said controller executes the processes of
acquiring a first image,
discriminating whether or not said executable output process has been performed on said first image by determining the region on said first image associated with said executable output process, and
determining said executable output process discriminated as having been performed on said first image by said process of discriminating, as a setting for an output process on a second image different from said first image.

2. The image processing apparatus according to claim 1, being connectable to a control apparatus for making the setting for the output process on said second image for said image processing apparatus, wherein
said controller further executes a process of transmitting the setting for said executable output process determined by said process of determining to said control apparatus so as to be usable as the setting for the output process on said second image.

3. The image processing apparatus according to claim 2, wherein
said control apparatus makes the setting for the output process on said second image using a printer driver, and
said controller transmits, in said process of transmitting, the setting for said executable output process determined by said process of determining to said control apparatus so as to be usable as a setting for said printer driver.

4. The image processing apparatus according to claim 1, wherein
said executable output process includes post-processing to be performed on a recording sheet on which the image has been formed, and
information in which said post-processing as said executable output process is associated with a region on the image on which said post-processing can be performed is previously stored in the predetermined region of said memory.

5. The image processing apparatus according to claim 4, wherein
said post-processing to be performed on said recording sheet includes a stapling process, and
information in which said stapling process as said executable output process is associated with a region on the image on which said stapling process can be performed is previously stored in the predetermined region of said memory.

6. The image processing apparatus according to claim 4, wherein
said post-processing to be performed on said recording sheet includes a punching process, and
information in which said punching process as said executable output process is associated with a region on the image on which said punching process can be performed is previously stored in the predetermined region of said memory.

7. The image processing apparatus according to claim 1, wherein
said executable output process includes an image composing process of composing a predetermined image, and
information in which said image composing process of composing said predetermined image as said executable output process is associated with a region on the image on which said image composing process can be performed is previously stored in the predetermined region of said memory.

8. The image processing apparatus according to claim 1, wherein
said executable output process includes a combining process of combining images of a plurality of pages into a single page, and
information in which said combining process as said executable output process is associated with a blank region on the image occurring in said combining process is previously stored in the predetermined region of said memory.

9. The image processing apparatus according to claim 1, wherein said controller acquires data of said first image by scanning a document in said process of acquiring.

10. The image processing apparatus according to claim 1, wherein said controller acquires data of said first image from another apparatus in said process of acquiring.

11. An image processing system comprising:
an image processing apparatus; and
a control apparatus connected to said image processing apparatus, wherein
information in which an executable output process is associated with a region on an image on which said executable output process is to be performed is previously stored in a predetermined region of a memory of said image processing apparatus,
a controller of said image processing apparatus executes the processes of
acquiring a first image,
discriminating whether or not said executable output process has been performed on said first image by determining the region on said first image associated with said executable output process, and
transmitting a setting of said executable output process discriminated as having been performed on said first image by said process of discriminating, to said control apparatus, and
upon receipt of the setting of said executable output process transmitted from said image processing apparatus, a controller of said control apparatus executes a process of determining the received setting of said executable output process, as a setting for an output process on a second image different from said first image.

12. The image processing system according to claim 11, wherein said control apparatus makes the setting for the output process on said second image using a printer driver, and the controller of said control apparatus determines the setting for said executable output process received from said image processing apparatus, as a setting for an output process in said printer driver.

13. An image processing method in an image processing apparatus, wherein information in which an executable output process is associated with a region on an image on which said executable output process is to be performed is previously stored in a predetermined region of a memory of said image processing apparatus, said image processing method comprising the steps of:
acquiring a first image;
discriminating whether or not said executable output process has been performed on said first image by determining the region on said first image associated with said executable output process; and
determining said executable output process discriminated as having been performed on said first image by said step of discriminating, as a setting for an output process on a second image different from said first image.

14. The image processing method according to claim 13, wherein said image processing apparatus is connectable to a control apparatus for making the setting for the output process on said second image for said image processing apparatus, said image processing method further comprising a step of transmitting the setting for said executable output process determined by said step of determining to said control apparatus so as to be usable as the setting for the output process on said second image.

15. The image processing method according to claim 14, wherein
said control apparatus makes the setting for the output process on said second image using a printer driver, and
in said step of transmitting, the setting for said executable output process determined in said step of determining is transmitted to said control apparatus so as to be usable as the setting for said printer driver.

16. A recording medium having recorded thereon an image processing program for causing a controller of an image processing apparatus to execute image processing, said recording medium being readable by said controller, wherein
information in which an executable output process is associated with a region on an image on which said executable output process is to be performed is previously stored in a predetermined region of a memory of said image processing apparatus, and
said image processing program causes said controller to execute the steps of
acquiring a first image,
discriminating whether or not said executable output process has been performed on said first image by determining the region on said first image associated with said executable output process, and
determining said executable output process discriminated as having been performed on said first image by said step of discriminating, as a setting for an output process on a second image different from said first image.

17. The recording medium having recorded thereon said image processing program according to claim 16, wherein
said image processing apparatus is connectable to a control apparatus for making the setting for the output process on said second image for said image processing apparatus, and
said image processing program causes said controller to further execute a step of transmitting the setting for said executable output process determined by said step of determining to said control apparatus so as to be usable as the setting for the output process on said second image.

18. The recording medium having recorded thereon said image processing program according to claim 17, wherein
said control apparatus makes the setting for the output process on said second image using a printer driver, and
in said step of transmitting, the setting for said executable output process determined by said process of determining is transmitted to said control apparatus so as to be usable as the setting for said printer driver.
